(19) United States
(12) Patent Application Publication
(10) Pub. No.: US 2012/0006193 A1
(43) Pub. Date: Jan. 12, 2012

(54) Adsorption-desorption apparatus and process

(76) Inventors: Subir Roychoudhury, Madison, CT (US); Christian Junaedi, Cheshire, CT (US); James Knox, Union Grove, AL (US)

(21) Appl. No.: 13/135,556

(22) Filed: Jul. 8, 2011

Related U.S. Application Data
(60) Provisional application No. 61/399,245, filed on Jul. 9, 2010.

(51) Int. Cl. B01D 53/02; B01D 53/30

(52) U.S. Cl. 95/11; 96/111; 96/115; 95/26

(57) ABSTRACT

An apparatus and process for thermally-linked adsorption-desorption. The process involves (a) at least one pair of adjacent sorbent beds, referenced herein as first and second sorbent beds, each pair of adjacent beds being thermally-linked one to the other through a thermally conductive wall; wherein each sorbent bed comprises a heat conductive foam, such as a reticulated metallic foam or sponge, having a sorbent coated thereon; then (b) alternating a flowstream between the beds such that at least one bed operates in adsorption cycle to remove target compound(s) from the flowstream with generation of heat of adsorption, which is conductively transferred away from the first bed towards the second bed, while operating the second bed in desorption cycle to remove the adsorbed target compound(s).

### CROSS REFERENCE TO RELATED APPLICATION

This invention claims the benefit of U.S. provisional patent application Ser. No. 61/399,245, filed Jul. 9, 2010.

### GOVERNMENT RIGHTS

This invention was made with government support under Contract No. NNM06AB36C sponsored by the National Aeronautics and Space Administration. The U.S. Government holds certain rights in this invention.

### FIELD OF THE INVENTION

This invention pertains to an apparatus and an adsorption-desorption process for removing one or more components from a flowstream. More specifically, this invention pertains to an apparatus and an adsorption-desorption process for removing one or more contaminants, such as carbon dioxide or a volatile organic compound (VOC), or removing another target compound, such as water, from a gaseous flowstream.

The invention finds utility in any application wherein air quality needs to be upgraded by removing from the air a volatile compound hazardous to human health. Advantageously, the invention finds utility in controlling the quality of cabin air in a spacecraft and air quality in an astronaut's ventilation loop. The invention also finds utility in collecting a desirable compound from a flowstream. As an example, water may be removed from an astronaut's ventilation loop to provide an acceptable humidity level; while the adsorbed water can be recovered and utilized elsewhere.

### BACKGROUND OF THE INVENTION

Adsorption processes are well known for removing a component, hereinafter “the target compound,” from a flowstream comprising two or more components (i.e., chemical compounds). Such processes typically comprise passing the flowstream over or through a sorbent material, which is typically provided as a bed containing a plurality of sorbent pellets or provided as an array of tubes or plates filled with or stacked with solid sorbent particles. Alternatively, the sorbent material can comprise a thermally non-conductive support in the form of pellets or tubes upon which the sorbent is coated or deposited. Conventional supports comprise a ceramic or refractory material, such as, alumina or silica-alumina. The sorbent comprises a chemical compound or composition capable of adsorbing the target compound from the flowstream. Molecular sieves (zeolites) are well known sorbents capable of adsorbing water and VOC's from a flowstream; whereas primary, secondary, and tertiary amines are known to react reversibly with carbon dioxide.

The prior art recognizes several disadvantages to conventional adsorption systems. Specifically, when the disposable sorbent material becomes saturated with the target compound, the adsorption process must be interrupted to provide fresh sorbent. One method involves discarding the used sorbent material and replacing it with fresh sorbent; but this method is clearly too costly and time consuming. Alternatively, the sorbent material might be regenerable. During regeneration, the flowstream and adsorption process are interrupted, while the sorbent material is subjected to a desorption step. The desorption step typically involves heating the sorbent material to an elevated temperature and/or subjecting the sorbent material to a reduced pressure so as to desorb the adsorbed target compound. Afterwards, the regenerated sorbent material is returned to service, and the flowstream is re-started for another adsorption cycle. Thermal cycling of one bed of sorbent material between adsorption and desorption cycles suffers from inefficiency, because the adsorption cycle is interrupted. As a further disadvantage, the temperature and/or pressure conditions of the adsorption and desorption cycles may need to be maintained in narrow operating range(s), which may require a more complex control algorithm. Furthermore, the more complex the system, the more likely the system will add considerable weight and cost to the adsorption process, a factor that is unacceptable in many applications, such as spacecraft and mobile applications.

To provide for greater process efficiency, temperature swing and pressure swing adsorption techniques have been employed. In these processes, two or more beds containing sorbent material are provided. At any given time, one or more beds will be operating in adsorption mode, while one or more other beds will be operating in desorption mode. The beds are alternately cycled between the adsorption and desorption processes; while the flowstream is alternated among the bed(s) operating in the adsorption cycle. Thus, the process is continuous, because the adsorption step is not intermittently shut down. In typical operation, these beds are physically separated, meaning not in direct physical or thermal contact; and each bed requires its own temperature and/or pressure controllers. While thermal and pressure swing adsorption-desorption processes offer certain advantages over single bed processes, the regeneration cycle is still problematic and inefficient.

In recent years, the advantages of thermally-linked adsorption-desorption processes have been recognized, as described for example in U.S. Pat. No. 5,876,488 and U.S. Pat. No. 6,364,938 B1. In this method, at least two sorbent beds are provided, wherein each bed is placed in thermal contact through a heat-conductive wall with at least one other bed. Each bed is filled with a structured sorbent material comprising a heat-conductive foam, preferably, a metal foam; and a sorbent is packed into the void spaces of the foam. As the flowstream is passed through the bed(s) in adsorption cycle and the target compound is adsorbed, the temperature of these bed(s) increases due to the exothermic adsorption process (i.e., heat released during the adsorption of the target compound). The heat is transferred through the heat-conductive foam and wall(s) away from the bed(s) in adsorption cycle into the bed(s) in desorption cycle, where the heat is gainfully used to desorb the adsorbed target compound. When the bed(s) in the adsorption cycle are saturated with the target compound or at some pre-determined adsorption concentration or time (i.e., breakthrough time), the flowstream is stopped into the adsorption bed(s) and started in the desorption bed(s), thus alternating the adsorption and desorption cycles among the beds. Thus, thermally-linked adsorption-desorption provides for an uninterrupted flowstream, continuous adsorption-desorption cycles, and more efficient heat integration. On the other hand, heat transfer from the sorbent material to the heat conductive foam is not optimal.

In spacecraft and aeronautical applications, constraints on volume, weight and power payloads are well documented. Life support systems that maintain cabin air quality or air quality in an astronaut's ventilation loop are no exception. The current state of the art carbon dioxide/water removal system onboard the International Space Station, for example, uses beds packed with solid sorbent pellets that are disadvantageously large in volume and mass. More disadvantageously, the pellets are prone to break-down generating dust that clogs and contaminates the system. Most disadvantageously, the thermal conductivity of such packed beds, typically molecular sieves, is inefficient, thereby increasing the power demands on heaters to assist the desorption process. Recently, advanced engineering structures, such as beads packed into aluminum foam and sorbent coated metals, have been investigated as sorbents to reduce volume and weight payload and increase thermal efficiency.

U.S. Pat. No. 7,141,092 B1, for example, discloses a method for regenerable adsorption employing a substrate structure comprising at least one layer of ultra-short channel length metal mesh (e.g., Microlith® brand metal mesh) capable of conducting an electrical current and upon which a zeolite sorbent is coated. In order to effect regeneration, the metal mesh is resistively heated thereby causing desorption of the adsorbed species. A similar structure is described by S. Roychoudhury, D. Walsh, and J. Perry, in “Microlith Based Sorber for Removal of Environmental Contaminants,” SAE publication no. 2004-01-2442, SAE International, 2004.

A somewhat similar method is described by D. F. Howard, J. L. Perry, J. C. Knox, and C. Junaedi, PhD. in “Engineered Structured Sorbents for the Adsorption of Carbon Dioxide and Water Vapor from Manned Spacecraft Atmospheres: Applications and Testing,” SAE publication no. 2009-01-2444, SAE International, 2009. In this publication, a thermally-linked bulk desiccant is taught to be constructed from a porous aluminum foam filled with particulate silica desiccant; and a CO₂ adsorber module is taught to be constructed from a zeolite-coated metal mesh sorbent (Microlith® brand metal mesh).

Finally, C. S. Iacomini, A. Powers, and H. L. Paul, in “PLSS Scale Demonstration of MTSA Temperature Swing Adsorption Bed Concept for CO₂ Removal/Rejection,” SAE publication no. 2009-01-2388, SAE International, 2009, disclose a sorber module comprising a reticulated aluminum foam coated with 13X molecular sieve sorbent for removing and rejecting carbon dioxide from an astronaut's ventilation loop.

Despite the above, the art would benefit from improvements in the apparatus and adsorption-desorption process for removing a target compound from a flowstream. In particular, the art would benefit from discovery of a compact and lightweight sorbent of improved robustness and structural stability and discovery of improved thermal efficiency and heat integration. Such a system could be employed advantageously in conventional terrestrial applications, and even more advantageously employed in spacecraft and in an astronaut's ventilation loop where all systems need to be robust and minimized with respect to mass, volume, and power.

### SUMMARY OF THE INVENTION

In one aspect, this invention pertains to an adsorption-desorption apparatus comprising:
(i) at least one pair of adjacent sorbent beds, referenced herein as first and second sorbent beds, each bed comprising a heat-conductive foam having coated thereon a sorbent capable of adsorbing a target compound;
(ii) a plurality of valves for directing a flowstream into and out of each sorbent bed;
(iii) optionally, a plurality of valves for exposing each sorbent bed to a pressure gradient;
(iv) a thermal conductor between each adjacent pair of sorbent beds for conducting heat between the beds;
(v) one or more sensors for detecting a concentration of the target compound in each bed or in an effluent flowstream from each bed;
(vi) a controller responsive to the sensor(s) or a predetermined time period for controlling operation of the plurality of valves.

In another aspect, this invention pertains to a thermally-linked process of adsorption-desorption comprising:

(a) providing an adsorption-desorption apparatus comprising:
(i) at least one pair of adjacent sorbent beds, referenced herein as first and second sorbent beds, each bed comprising a heat-conductive foam having coated thereon a sorbent capable of adsorbing a target compound;
(ii) a plurality of valves for directing a flowstream into and out of each sorbent bed;
(iii) optionally, a plurality of valves for exposing each sorbent bed to a pressure gradient;
(iv) a thermal conductor between each adjacent pair of sorbent beds for conducting heat between the beds;
(v) one or more sensors for detecting a concentration of the target compound in each bed or in an effluent flowstream from each bed;
(vi) a controller responsive to the sensor(s) or a predetermined time period for controlling operation of the plurality of valves;

(b) passing a flowstream comprising the target compound into the first sorbent bed under conditions sufficient to adsorb the target compound from the flowstream with production of heat of adsorption that is conductively transferred to the second sorbent bed;

(c) desorbing any target compound from the second sorbent bed and exiting said target compound from the bed;

(d) stopping the flowstream to the first sorbent bed at a predetermined adsorption time or when the concentration of target compound in the first sorbent bed or the flowstream exiting the first sorbent bed is at a predetermined level;

(e) passing the flowstream into the second sorbent bed under conditions sufficient to adsorb the target compound from the flowstream with production of heat of adsorption that is conductively transferred to the first sorbent bed;

(f) desorbing the adsorbed target compound from the first sorbent bed and passing said desorbed target compound from the first bed;

(g) stopping the flowstream to the second sorbent bed at a predetermined adsorption time or when a concentration of the target compound in the second sorbent bed or the flowstream from the second sorbent bed is at a predetermined level; and

(h) reiterating steps (b) through (h) so as to alternate each bed through adsorption and desorption cycles.

The above-described apparatus and adsorption-desorption process of this invention are advantageously employed to remove a target compound, for example, a bulk compound, a contaminant, or a trace compound, from a flowstream, and more advantageously, employed to provide a life-sustaining quality of cabin air in a spacecraft or in an astronaut's ventilation loop. Even more advantageously, as used in this invention the heat conductive foam having coated thereon a sorbent (referred to herein as the “sorbent structure”) offers the advantages of a lighter mass and smaller volume payload and greater structural stability as compared to packed pellet beds or packed foam beds of the prior art. Even more advantageously, the sorbent employed in this invention directly contacts a structural material of high thermal conductivity, herein the heat conductive foam, so that heat is quickly transported into or away from the material thereby assisting and improving desorption or adsorption, respectively.

### DRAWINGS

FIG. 1 illustrates an embodiment of the apparatus of this invention for use in the regenerable thermally-linked adsorption-desorption process of this invention.

FIG. 2 depicts a graph of inlet and outlet water partial pressures versus time for an embodiment of the process of this invention, wherein an inlet air flow rate of 10 standard liters per minute (slpm) and an inlet water partial pressure of 0.631 kPa were employed.

FIG. 3 depicts a graph of inlet and outlet water partial pressures versus time for an embodiment of the process of this invention, wherein an inlet air flow rate of 10 slpm and an inlet water partial pressure of 1.133 kPa were employed.

FIG. 4 depicts a graph of inlet and outlet water partial pressures versus time for an embodiment of the process of this invention, wherein an inlet air flow rate of 10 slpm and an inlet water partial pressure of 1.630 kPa were employed.

FIG. 5 depicts a graph of inlet and outlet water partial pressures versus time for an embodiment of the process of this invention, wherein an inlet air flow rate of 20 slpm and an inlet water partial pressure of 0.632 kPa were employed.

FIG. 6 depicts a graph of inlet and outlet water partial pressures versus time for an embodiment of the process of this invention, wherein an inlet air flow rate of 20 slpm and an inlet water partial pressure of 1.124 kPa were employed.

FIG. 7 depicts a graph of inlet and outlet water partial pressures versus time for an embodiment of the process of this invention, wherein an inlet air flow rate of 20 slpm and an inlet water partial pressure of 1.619 kPa were employed.

### DETAILED DESCRIPTION OF THE INVENTION

The following definitions are provided for understanding the apparatus and the adsorption-desorption process of this invention.

The term “adsorption” shall refer to adherence of atoms, ions, or molecules of a gas or liquid to the surface of another substance referred to herein as “the sorbent.” In the invention described herein, a specified gaseous molecule is preferentially adsorbed onto the sorbent from a flowstream comprising a mixture of gaseous molecules including the specified gaseous molecule.

The term “desorption” shall refer to the process of removing an adsorbed species, preferably an adsorbed molecule, from the sorbent onto which it is adsorbed. Desorption can be accomplished by exposing the sorbent containing the adsorbed species, referred to herein as the “target compound,” to reduced pressure, or by purging the sorbent with a purge stream capable of removing the target compound, or by exposing the sorbent to another substance that is more strongly adsorbed as compared to the target compound, or by heating the sorbent, or by some combination of the aforementioned methods. If purging is used, then the concentration of target compound in the purge stream may be any concentration that does not inhibit the desorption process. Generally, the concentration of target compound in the purge stream is less than about 5 percent, and preferably, less than about 1 percent by volume, based on the total volume of the purge stream. Even more preferably, the concentration of the target compound in the purge stream is less than about 5 percent, still more preferably, less than about 1 percent, and most preferably, less than about 0.5 percent of the concentration of the target compound in the flowstream being treated by the process.

For the purposes of this invention, the term “target compound” shall refer to any molecule or chemical compound that is adsorbed by the sorbent. The term as used herein includes chemical compounds that are undesirable and/or dangerous to humans and/or animals beyond a threshold concentration as known in the art, as well as compounds that may be valuable to collect for use elsewhere. Examples of target compounds embraced by this invention include, without limitation, carbon dioxide, hydrogen sulfide, ammonia, and volatile organic compounds (VOC's) including, for instance, formaldehyde, acetaldehyde, methyl tertiary butyl ether (MTBE), and volatile solvents including acetone, ethyl acetate, methanol, and ethanol. It is well known that these compounds should be present in trace concentrations for an environment to be life-sustaining. Water is also included in the list, because water is desirably maintained at an acceptable humidity level; and it may be valuable to collect water from the atmosphere for use elsewhere. The target compound may also comprise a mixture of any of the aforementioned compounds, a preferred example of which consists of a mixture of water and carbon dioxide.

As used herein, the term “flowstream” shall refer to a liquid or gaseous mixture comprising two or more molecules or chemical elements including the target compound(s). Prior to the adsorption process of this invention, the flowstream will contain a higher concentration of target compound or target compounds, as the case may be. The flowstream exiting the adsorption process will contain a reduced concentration of the target compound(s). Besides the target compound(s), the gaseous flowstream typically comprises nitrogen and oxygen.

The concentration of the target compound in the flowstream treated by the process of this invention may range from about 10 parts per million (ppm) on a molar basis to less than about 15 mole percent. The concentration varies with the chemical composition of the target compound and the source of the flowstream. For spacecraft, the concentration of carbon dioxide in the flowstream to be treated is typically less than about 0.7 percent, but may be as high as about 2 mole percent for brief periods. The concentration of carbon dioxide outside spacecraft environments, for example, in coal-fired power plant smokestacks, may be as high as 10 to 15 mole percent. The concentration of water in a typical spacecraft environment is below 1.8 mole percent, but occasionally may be as high as 2.5 mole percent. The desired post-treatment concentration of the target compound in the flowstream also varies with the chemical composition of the target compound, some target compounds being required to be present in less than 10 ppm concentration, while others being suitably present in the 10 ppm to 8,000 ppm concentration range.

With reference to the concentration of the target compound in the sorbent bed, the term “a predetermined adsorption level” refers to the concentration of target compound deemed to place the sorbent in a substantively loaded condition and therefore ready to be cycled through desorption. The term “substantively loaded” shall refer herein to a loading of target compound onto the sorbent of greater than about 50 percent, preferably greater than about 70 percent, more preferably greater than about 80 percent, and most preferably, at about 100 percent of the maximum allowable concentration (i.e., saturation level) of specific target compound adsorbed. The maximum allowable concentration will vary depending upon the specific target compound and the capacity of the sorbent to adsorb such target compound.

For the purposes of this invention, the term “a predetermined adsorption time” shall refer to a time measured from the start of the adsorption cycle to the moment at which the adsorption cycle is stopped and the desorption cycle is begun. The predetermined adsorption time is generally based on knowledge of the quantity of target compound adsorbed onto the sorbent per unit time period, which depends upon the concentration of the specific target compound in the inlet flowstream, the capacity of the sorbent toward adsorption of the target compound, the flow rate of the flowstream, the quantity of sorbent in the sorbent bed(s), and the operating temperature and pressure.

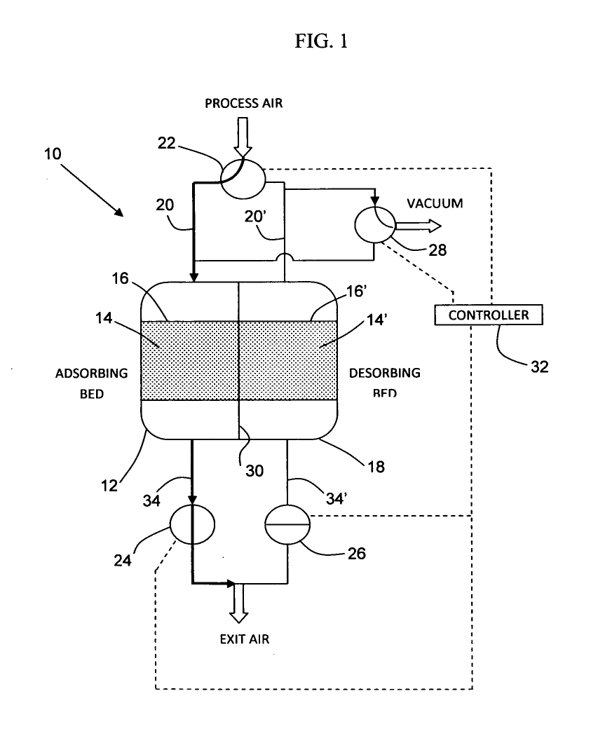

FIG. 1 illustrates a preferred embodiment of this invention comprising the thermally-linked adsorption-desorption apparatus, which is denoted generally by the numeral 10. The system 10 includes a pair of sorption beds 12 and 18, each of which contains a sorbent 14 and 14′ coated onto a metallic foam matrix 16 and 16′, respectively. The two beds 12 and 18 share a common wall 30 constructed from a heat conductive material (thermally conductive, e.g., metal). Inlet lines 20 and 20′ extend from the atmosphere of the environment being purged of a target compound to each of the sorption beds 12 and 18, respectively. A control valve 22 selectively controls which of the inlet lines 20 or 20′ receives the environmental atmosphere being purged and delivers it to the respective bed 12 or 18, so that only one of the beds 12 or 18 is used at any one time in adsorption cycle. Outlet lines 34 and 34′ deliver purged atmosphere from the beds 12 and 18, respectively, back into the environment. Control valves 24 and 26 operate selectively to open one of the lines 34 or 34′, respectively, to exit the purged stream.

As shown in the figure, in the absorption cycle a stream 20 of inlet flow containing at least one target compound to be removed is provided to bed 12 through a three-way valve 22. As the flowstream containing the target compound contacts the sorbent coating 14 in passage through sorbent bed 12, the target compound is adsorbed onto the bed 12 releasing heat. Purged flowstream 34 from which the target compound has been removed exits to the environment through valve 24.

In the process of the invention as described in steps (a) through (h) hereinabove, the adsorption step (b) and the desorption step (c) occur essentially simultaneously; and likewise, the adsorption step (e) and desorption step (f) also occur simultaneously. Thus at the same time that sorbent 14 in sorption bed 12 is operating in adsorbent mode, sorbent 14′ in bed 18 is operating in the desorption or regeneration cycle. This involves positioning valve 22 to stop the flowstream into bed 18 and also closing valve 26 to prevent flowstream containing the target compound from exiting the bed and entering the environment. The adsorbed target compound is desorbed from sorbent bed 18 by exposing bed 18 to reduced pressure, or by subjecting bed 18 to a purging flow substantially free of the target compound, and preferably having essentially no target compound, or by a combination of both reduced pressure and purging techniques. In the embodiment illustrated in FIG. 1, a reduced pressure means is used to regenerate the bed. Specifically, sorbent 14′ is exposed to a reduced pressure, such as a vacuum source as in a space vacuum, through valve 28. Exposure of the sorbent 14′ to a reduced pressure gradient enhances the overall desorption of the target compound. As an alternative, desorption can be effected by heating the sorbent 14′ in bed 18, provided that the heat is directed into sorbent bed 18 and not into sorbent bed 12 in adsorption cycle.

After a predetermined time interval or at a specified target compound concentration in bed 12 or effluent stream 34, the absorption and desorption cycles are reversed such that sorbent bed 12 enters the desorption cycle and sorbent bed 18 enters the adsorption cycle. This reversal is accomplished by reversing the valve settings 22, 24, and 26 shown in the figure so that the flowstream is directed through line 20′ to sorbent bed 18 while bed 12 is exposed to the purge gas or reduced pressure source, e.g., vacuum, via valve 28. The valves can be controlled by controller 32, which is responsive to a sensor (not shown) that detects the level of target compound in the beds 12 and 18 or effluent streams 34 and 34′, or alternatively, is responsive to a pre-determined absorption time interval.

While the above adsorption-desorption apparatus has been described as comprising two sorbent beds, it is to be understood that the apparatus is not limited to two beds. A plurality of beds may be employed in any manner that provides for each bed to be thermally-linked to at least one other adjacent bed, as in a pair of adjacent beds. A preferred number of sorbent beds ranges from 2 to about 10, preferably, 2 to about 6.

The sorbent beds are secured inside a housing, which is constructed of any suitable material capable of holding the sorbent structure and withstanding the temperatures and pressures of the process. A suitable material is stainless steel or aluminum, although the invention should not be limited thereto. Thermal-linking of the beds is achieved by constructing each pair of adjacent beds with a commonly-shared thermally-conductive wall. Each wall that is shared or physically contacting two beds is required to be constructed from a heat conductive material, suitable examples of which include but are not limited to aluminum, titanium, copper, iron, nickel, steel, aluminum steel, tin, noble metals, such as platinum, silver, and gold, as well as alloys of the aforementioned metals. The preferred heat conductive material comprises stainless steel, or aluminum or titanium provided either as pure metal or metal alloy.

Each sorbent bed is constructed from a heat conductive foam, preferably but not limited to, a reticulated metallic foam, which also may be referred to as a “porous metal” or “metal sponge.” The word “reticulated” refers to a porous or net-like structure. Metal foams comprise a cellular structure consisting of a solid metal containing a large volume of gas-filled pores and/or channels. A metal foam can be compared structurally to a polyurethane foam, excepting of course that the chemical compositions are distinctly different. The pore size of the metal foam can range from several nanometers (nm) to about 10 millimeters (mm) in diameter. Preferably, the foam contains from about 5 to about 80 pores per inch length (ppi), more preferably, from about 20 to about 40 ppi. The pores can be sealed (closed-cell) or they can form an interconnected network (open-cell). Metal foams tend to have a high porosity; from about 70 to about 95 percent of the foam typically consists of void space. The smaller the void space, the higher will be the density of the foam and consequently its strength, because then the foam has more metal struts or structure. The porosity of the metal foam is usually presented as a “relative density,” defined as the density of the foam divided by the density of the solid (i.e., without pores) parent material from which the foam is made. Advantageously, the relative density of the foam ranges from about 2 to about 15 percent, preferably, in a range from about 8 to about 12 percent.

The metal foams can be prepared by different methods. In one method, a base metal from which the foam is to be made is resolved to a liquid state, foamed directly, and then reticulated. In other methods, a block of metal is reticulated by stretching or metal powder is formed into a reticulated pattern via electron beam manufacturing techniques. Properties such as stiffness, crush strength, electrical conductivity, and thermal conductivity will depend upon the specific base material, the structure of the struts, the cell structure, and relative density.

Heat conductive metal foams suitable for this invention include, without limitation, reticulated foams prepared from aluminum, titanium, copper, nickel, iron, steel, aluminum steel, and tin as well as alloys of each of the aforementioned metals. While reticulated metal foams prepared from platinum, silver, iridium, gold and other noble metals can be used, including alloys of such metals, they may be less preferred based on cost considerations. The art generally refers to “reticulated” metal foams as those metal foams prepared by entrapping gas in a molten metal or by depositing metal on a polymer foam and then removing the polymer foam. Preferred reticulated metal foams include stainless steel, and aluminum and titanium either as pure metal or metal alloy. Reticulated metal foams are commercially available; for example, reticulated aluminum foam can be obtained as DUOCELL® brand aluminum foam from ERG Materials and Aerospace Corporation, Oakland, Calif. Metal foams or lattices prepared by an Electron Beam Melting (EBM) technique can also be suitably employed in this invention, although at this time EBM lattices may be somewhat more difficult to obtain commercially. Arcam sells EBM machines; and two companies, Synergeering Group and XinFuMind, have Arcam Titanium EBM capabilities.

The sorbent that is coated onto the metal foam can be any conventional sorbent material. Non-limiting examples of suitable sorbents include various amines for adsorbing carbon dioxide, as well as various molecular sieves (zeolites) including aluminosilicates and phosphoaluminosilicates, and metal oxides, which are capable of adsorbing carbon dioxide, water, ammonia, hydrogen sulfide, and various volatile organic compounds (VOC's). For adsorbing carbon dioxide any primary, secondary, or tertiary amine can be employed. Preferably, the amine is a secondary amine, more preferably, a secondary amine comprising a plurality of hydroxyl (—OH) groups. Among these amines are preferably employed diethanolamine, diisopropanolamine, and 2-hydroxypiperazine. Other preferred sorbents include molecular sieve 13X (MS-13X) and 5A (MS-5A) for removing water and carbon dioxide, and a wide variety of zeolites (silicates, aluminosilicates, phosphoaluminosilicates) acting as molecular sieves for removing ammonia and VOC's. Zeolite Y and zeolite HZSM-5 are particularly useful and preferred.

The sorbent is typically washcoated onto the thermally conductive foam. The procedure involves washing, dipping, brushing, or spraying the foam with one or more of a solution, slurry, or gel containing the sorbent, followed by drying and/or calcining to remove any volatile solvent and to cure or improve adherence of the sorbent onto the foam. The foam can be cleaned or pre-treated prior to washcoating. The washcoating procedure generally follows those well known in the art, as described, for example, in US application publication 2009/220697, in U.S. Pat. No. 7,541,010, U.S. Pat. No. 5,346,722, and U.S. Pat. No. 4,900,712, all incorporated herein by reference. The art also describes methods for coating, depositing, or synthesizing a molecular sieve (zeolite) onto a metal substrate or support. See, for example, US application publication 2009/0009049 A1, U.S. Pat. No. 6,500,490 B1, U.S. Pat. No. 5,325,916, U.S. Pat. No. 5,310,714, and international application publication WO 2008/143823 A1, all incorporated herein by reference. Sorbent-coated metal foams of the type disclosed herein may also be obtained from Precision Combustion, Inc., of North Haven, Conn., USA.

The loading of sorbent on the foam can be described in units of weight sorbent per unit volume of foam; and this advantageously ranges from about 0.2 grams sorbent per cubic inch of metal foam (g/in³) (12 mg/cm³) to about 4.1 g/in³ (250 mg/cm³). This description takes the gross dimensions of the foam into account. It is possible to define the loading of the sorbent in terms of weight sorbent per surface area of foam, which takes into consideration the surface area arising from the struts running throughout the foam. In order to convert from volume to surface area, one needs to know the surface area to volume ratio of the foam. One skilled in the art would know how to obtain this ratio from standard analytical techniques, for example, by measuring surface area by the Brunauer-Emmet-Teller (BET) method. The thickness and uniformity of the sorbent coating on the foam may vary widely depending upon the specific foam, cell structure, sorbent, and coating method selected. Analyses by scanning electron microscopy (SEM) may show coating thicknesses ranging from about 3 microns (μum) to about 400 μm or more.

Generally, the sorbent-coated heat conductive foam prepared as described hereinabove exhibits good adhesion. Specifically, the cumulative coating weight loss over about one hundred and twenty (120) thermal cycles is advantageously less than about 3 weight percent, preferably, less than about 1.5 weight percent, more preferably, less than about 1.0 weight percent, and most preferably, less than about 0.7 weight percent. For these purposes, a “thermal cycle” is defined as the operation that raises at a specific rate the temperature of the sorbent-coated foam from the temperature of the adsorption cycle to the higher temperature of the regeneration or desorption cycle, where it may be maintained for a given time, and then lowers the temperature at a specific rate back to the original adsorption temperature. Weight loss of the coating tends to decrease with increasing thermal cycling; thus beyond about 120 thermal cycles, essentially no further weight loss may be found. Additionally, the sorbent-coated foam exhibits good durability. The coated foam readily survives more than about 120 thermal cycles of up to 200° C., which is a typical regeneration temperature of an adsorption-desorption process.

The heat conductive foam, sometimes referred to as the “heat conductive sorbent structure,” is brazed directly to the interior walls of the housing, the term “brazing” referring to metal-to-metal contact. The sorbent washcoating procedure may be conducted prior to or after brazing. Either way, efforts should be made to avoid exposing the sorbent washcoating to excessive temperatures that might damage the washcoating. Thus, while from the point of view of washcoating, it may be advantageous to washcoat the sorbent prior to brazing; in fact, the washcoating is then subjected to the higher brazing temperatures. Accordingly, it may be preferred to first braze the sorbent structure into the housing and afterwards perform the washcoating with the sorbent. This method has the disadvantage that the washcoating is conducted with the housing in place; but still it may be preferred. The housing itself is advantageously constructed with appropriate fixtures for attaching the manifolds to define inlet and outlet flowstream lines, such that the complete apparatus is readily assembled without impacting the sorbent and washcoating.

The plurality of valves for directing the flowstream into and out of each sorbent bed can be any of such flow-controller valves that are available commercially, as known to the person skilled in the art. Likewise, the plurality of valves for exposing each sorbent bed to a pressure gradient are any of such pressure control valves that are also known to the skilled person and found commercially. The term “pressure gradient” means that the pressure control valve connects two environments at different pressure. In this instance, the pressure of the target compound in the sorbent bed when the bed is loaded will be higher than the pressure of the target compound in an environment outside the sorbent bed. Accordingly, the target compound can be removed from the sorbent bed by opening the relevant valve and exposing the sorbent bed to a lower pressure environment, e.g., space vacuum. The sensors detecting a concentration of the target compound in each sorbent bed or in an effluent flowstream from each sorbent bed can be any of the commercially available sensors capable of detecting the specific target compound of interest. Such sensors include, for example, flame ionization detectors, thermal conductivity detectors and hygrometers or dew point sensors. Finally, the controller responsive to the sensor(s) or a predetermined time period for controlling operation of the plurality of valves can be obtained commercially or constructed by a person skilled in the art.

The adsorption-desorption process of this invention can be conducted under any process conditions that provide for acceptable removal of the target compound from a flowstream containing the target compound. The specific process conditions will be determined by the target compound of interest and heat and mass balance considerations. The following process conditions, specifically, ranges of temperature, pressure, and gas hourly space velocity, are presented for guidance purposes; however, other process ranges may also be found to be operable. The adsorption cycle is operated advantageously at a sorbent bed temperature ranging from about 5° C. to about 50° C. and a pressure ranging from about 1 atm (101 kPa) to about 5 atm (506 kPa). Advantageously, during the adsorption cycle the flowstream containing the target compound is fed to the sorbent bed at a gas hourly space velocity ranging from about 1,000 ml total gas flow per ml sorbent bed per hour (hr⁻¹) to about 100,000 hr⁻¹. Advantageously, the desorption cycle is operated and a partial pressure of the target compound ranging from about 0.0005 atm (0.05 kPa) to about 1 atm (101 kPa) or a total pressure ranging from about 0.0005 atm (0.05 kPa) to about 1 atm (101 kPa). The desorption cycle can be operated at a temperature ranging from about ambient, taken as 21° C., to about 200° C. Advantageously, during the desorption cycle the target compound exits the sorbent bed at a gas hourly space velocity ranging from about 100 ml target compound per ml sorbent bed per hour (hr⁻¹) to about 5,000 hr⁻¹.

The process of this invention achieves a lower concentration of target compound in the effluent stream exiting from the adsorption-desorption apparatus during the adsorption phase, as compared with the concentration of target compound in the incoming flowstream. The concentration of each target compound in the effluent stream will vary with the specific target compound. Generally, however, the concentration of each target compound in the effluent stream is advantageously less than about 8,000 parts per million (ppm), preferably, less than about 5,000 ppm, more preferably, less than about 500 ppm, even more preferably, less than about 50 ppm, even more preferably, less than about 10 ppm, and most preferably, less than the minimum detectable concentration, calculated on a molar basis, based on the total number of moles of effluent stream exiting the adsorption bed during the adsorption phase.

### EMBODIMENTS OF THE INVENTION

The following embodiments of the invention are presented for illustrative purposes, but these embodiments so illustrated should not be construed to limit the invention in any manner. The ordinary person skilled in the art will recognize that various modifications and substitutions can be made to the illustrated embodiments, which fall within the spirit and scope of the invention as described herein.

In the following embodiments the analysis for water partial pressure was made by a dew-point technique using a chilled mirror hygrometer (EdgeTech Corporation). The principle of operation of a chilled mirror hygrometer can be found in the art, for example, online at http://www.yesinc.com/products/data/cmh/index.html., from which the following text is obtained. The technique involves chilling a surface, usually a metallic mirror, to a temperature at which water condensed on a surface of the mirror is in equilibrium with water vapor in a gas sample above the surface of the mirror. At this temperature, the mass of water on the surface of the mirror is neither increasing (which would happen if the surface were too cold) nor decreasing (which would happen if the surface were too warm).

The mirror is constructed from a material having acceptable thermal conductivity, such as silver or copper, and is plated with an inert metal, such as iridium, rubidium, nickel, or gold, to prevent tarnishing and oxidation. The mirror is chilled using a thermoelectric cooler, until dew just begins to form. A beam of light from a solid-state broadband light emitting diode is aimed at the surface of the mirror. A photodetector monitors reflected light. As a gas sample flows over the chilled mirror, dew droplets form on the mirror surface; and the reflected light is scattered. As the amount of reflected light decreases, the photodetector output also decreases. This in turn controls a thermoelectric heat pump via an analog or digital control system that maintains the mirror temperature at the dew point. A precision miniature platinum resistance thermometer (PRT) embedded in the mirror monitors the mirror temperature at the established dew point.

### Example 1

An adsorption-desorption apparatus according to the invention was constructed along the lines of FIG. 1. In this instance, the apparatus consisted of an aluminum housing into which were arranged 4 rectangular aluminum chambers, which for notation purposes were labeled chambers “A”, “B”, “C”, and “D”. The chambers were placed side-by-side with parallel flow paths, such that each chamber shared at least one common wall with an adjacent chamber. Each chamber was filled with an aluminum reticulated foam (ERG Materials and Aerospace Corporation), the foam being brazed onto the walls of each chamber for maximum heat transfer between the chambers. The reticulated aluminum foam had 40 pores per inch length (16 pores per cm length). Following assembly, the aluminum reticulated foam in each chamber was washcoated with a sorbent, specifically, zeolite 13X, and then dried. The zeolite sorbent loading was 1.4 g/in³ (85 mg/cm³), based on the free-standing aluminum foam exclusive of the housing. A manifold comprising a plurality of conduits and valves was connected to the apparatus so as to feed a common flowstream to two beds spaced alternately; that is, chambers A and C were manifolded together and chambers B and D were manifolded together. By so doing, chambers A and C together were considered one sorbent bed, while chambers B and D together were considered a second sorbent bed. The manifold also allowed for exit of a common flowstream from chambers A and C and another common flowstream from chambers B and D. Each bed (two manifolded chambers) was also connected to a vacuum pump, with valving that was similar to that shown in FIG. 1. Each chamber had a volume of 2.63 in³ (calculated: 0.5″×1.5″×3.5″) (43 cm³). Thus, the weight of the zeolite sorbent for each bed, i.e., two absorbing chambers, was 7.4 g (calculated as: 2×2.63 in³×1.4 g/in³).

The two beds were operated in a cyclic manner, such that one bed was subjected to an adsorption cycle by feeding a flowstream containing the target compound into the bed; while the other bed was subjected to a desorption cycle by exposure to a vacuum (˜5 ton=0.67 kPa). At a designated time period of 180 seconds (3 minutes), the valves were automatically operated to reverse the functions of the two beds. Specifically, at the start chambers A and C were operated in adsorption cycle, while chambers B and D were operated in desorption cycle. Then, at 180 seconds (one-half cycle time) the flow was switched such that chambers A and C were operated in desorption cycle, while chambers B and D were operated in absorption cycle. After another 180 seconds or one-half cycle, the flow was again alternated, and so forth.

A flowstream comprising humidified air, specifically for this example, air having an inlet water partial pressure of 0.631 kPa, was fed at a flow rate of 10 standard liters per minute (10 slpm, taken herein as 0° C. and 1 atm (101 kPa) to the bed (two chambers) in the adsorption cycle. An outlet stream of humidified air exiting the bed was analyzed for its outlet water partial pressure. A comparison of the measured water partial pressures in the inlet and outlet streams provided the percentage of water removed from the flowstream.

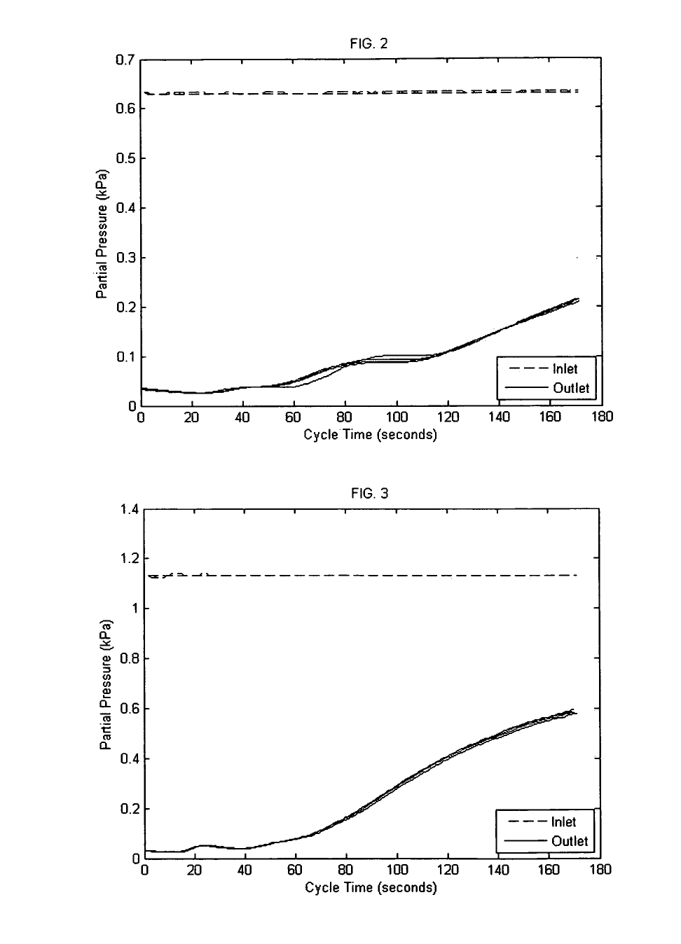

Since the adsorption and desorption cycles were each 180 seconds (3 minutes), one complete cycle through adsorption and desorption equaled 6 minutes. A graph of water partial pressures in the inlet and outlet flowstreams versus time is shown for four overlaid half-cycles in FIG. 2. After operation for more than 40 half cycles, when reproducible cycles were observed, calculations over four half-cycles gave a result of 84.9 percent removal of water.

### Example 2

Example 1 was repeated with the following process conditions: inlet air flow rate was 10 slpm and the inlet water partial pressure was 1.133 kPa. A graph of water partial pressures in the inlet and outlet flowstreams versus time is shown for four overlaid half-cycles in FIG. 3. After operation for more than 40 half cycles, when reproducible cycles were observed, calculations over four half-cycles gave a result of 77.3 percent removal of water.

### Example 3

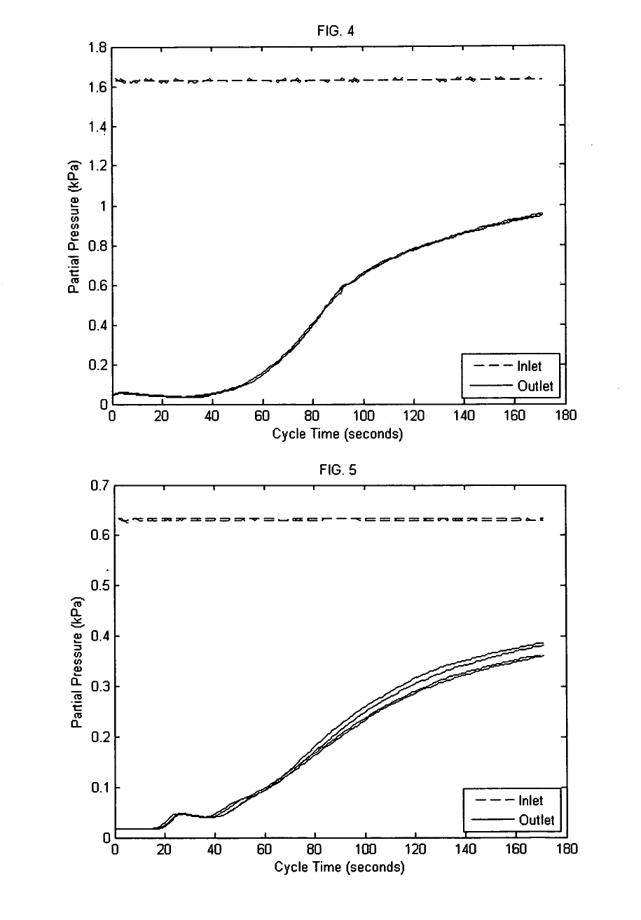

Example 1 was repeated with the following process conditions: inlet air flow rate was 10 slpm and the inlet water partial pressure was 1.630 kPa. A graph of water partial pressures in the inlet and outlet flowstreams versus time is shown for four overlaid half-cycles in FIG. 4. After operation for more than 40 half cycles, when reproducible cycles were observed, calculations over four half-cycles gave a result of 70.8 percent removal of water.

### Example 4

Example 1 was repeated using the following conditions: inlet air flow rate was 20 slpm and inlet water partial pressure was 0.632 kPa. A graph of water partial pressures in the inlet and outlet flowstreams versus time is shown for four overlaid half-cycles in FIG. 5. After operation for more than 40 half cycles, when reproducible cycles were observed, calculations over four half-cycles gave a result of 69.2 percent removal of water.

### Example 5

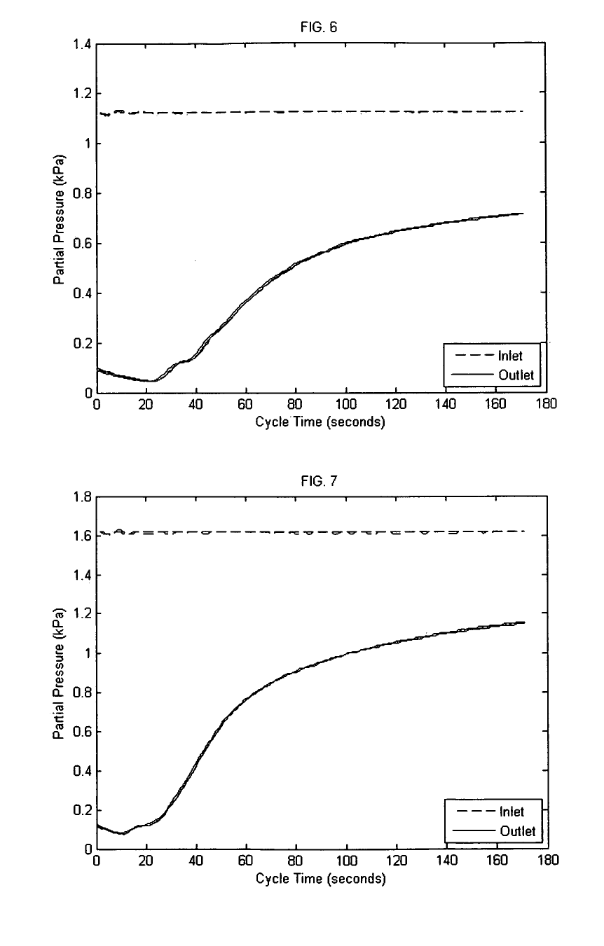

Example 1 was repeated using the following conditions: inlet air flow rate was 20 slpm and inlet water partial pressure was 1.124 kPa. A graph of water partial pressures in the inlet and outlet flowstreams versus time is shown for four overlaid half-cycles in FIG. 6. After operation for more than 40 half cycles, when reproducible cycles were observed, calculations over four half-cycles gave a result of 59.9 percent removal of water.

### Example 6

Example 1 was repeated using the following conditions: inlet air flow rate was 20 slpm and inlet water partial pressure was 1.619 kPa. A graph of water partial pressures in the inlet and outlet flowstreams versus time is shown for four overlaid half-cycles in FIG. 7. After operation for more than 40 half cycles, when reproducible cycles were observed, calculations over four half-cycles gave a result of 51.6 percent removal of water.

In all of the above examples, no significant deterioration of the sorbent was found over the full test time.

While the present invention has been described in considerable detail hereinabove, other configurations exhibiting the characteristics taught herein are contemplated for the apparatus and process of adsorption-desorption described in this invention. Therefore, the spirit and scope of the invention should not be limited to the description of the preferred embodiments described herein.

1. An adsorption-desorption apparatus comprising:
(i) at least one pair of adjacent sorbent beds, referenced herein as first and second sorbent beds, each bed comprising a heat-conductive foam having coated thereon a sorbent capable of adsorbing a target compound;
(ii) a plurality of valves for directing a flowstream into and out of each sorbent bed;
(iii) optionally, a plurality of valves for exposing each sorbent bed to a pressure gradient;
(iv) a thermal conductor between each adjacent pair of sorbent beds for conducting heat between the beds;
(v) one or more sensors for detecting a concentration of the target compound in each bed or in an effluent flowstream from each bed;
(vi) a controller responsive to the sensor(s) or a predetermined time period for controlling operation of the plurality of valves.

2. The apparatus of claim 1 wherein the heat conductive foam comprises a reticulated metal foam wherein the metal is selected from aluminum, titanium, copper, nickel, iron, steel, aluminum steel, tin, platinum, silver, iridium, gold, and alloys of the aforementioned metals.

3. The apparatus of claim 1 wherein the heat conductive foam comprises a reticulated aluminum, titanium, or stainless steel foam having 5 to 80 pores per inch length and greater than 70 percent to less than 95 percent void space.

4. The apparatus of claim 1 wherein the heat conductive foam has a relative density from 2 to 15 percent.

5. The apparatus of claim 1 wherein the sorbent is selected from amines and molecular sieves, including aluminosilicates and phosphoaluminosilicates, and metal oxides.

6. The apparatus of claim 5 wherein the sorbent is selected from molecular sieve 13X, molecular sieve 5A, zeolite Y, and zeolite HZSM-5.

7. The apparatus of claim 1 wherein the sorbent is loaded onto the heat conductive foam in an amount ranging from 12 mg sorbent per cubic centimeter foam (mg/cm³) to 250 mg/cm³.

8. The apparatus of claim 1 wherein the thermal conductor is selected from aluminum, titanium, copper, iron, nickel, steel, aluminum steel, tin, platinum, silver, gold, and alloys of each of the aforementioned metals.

9. The apparatus of claim 1 comprising 2 to 10 sorbent beds, wherein each bed is thermally linked to at least one other adjacent bed.

10. A thermally-linked process of adsorption-desorption comprising:
(a) providing an adsorption-desorption apparatus comprising:
(i) at least one pair of adjacent sorbent beds, referenced herein as first and second sorbent beds, each bed comprising a heat-conductive foam having coated thereon a sorbent capable of adsorbing a target compound;
(ii) a plurality of valves for directing a flowstream into and out of each sorbent bed;
(iii) optionally, a plurality of valves for exposing each sorbent bed to a pressure gradient;
(iv) a thermal conductor between each adjacent pair of sorbent beds for conducting heat between the beds;
(v) one or more sensors for detecting a concentration of the target compound in each bed or in an effluent flowstream from each bed;
(vi) a controller responsive to the sensor(s) or a predetermined time period for controlling operation of the plurality of valves;
(b) passing a flowstream comprising the target compound into the first sorbent bed under conditions sufficient to adsorb the target compound from the flowstream with production of heat of adsorption that is conductively transferred away from the first sorbent bed towards the second sorbent bed;
(c) desorbing any target compound from the second sorbent bed and exiting said target compound from the bed;
(d) stopping the flowstream to the first sorbent bed at a predetermined adsorption time or when the concentration of target compound in the first sorbent bed or in the flowstream exiting the first sorbent bed is at a predetermined level;
(e) passing the flowstream into the second sorbent bed under conditions sufficient to adsorb the target compound from the flowstream with production of heat of adsorption that is transferred away from the second sorbent bed towards the first sorbent bed;
(f) desorbing the adsorbed target compound from the first sorbent bed and passing said desorbed target compound from the first bed;
(g) stopping the flowstream to the second sorbent bed at a predetermined adsorption time or when the concentration of target compound in the second sorbent bed or in the flowstream from the second sorbent bed is at a predetermined level; and
(h) reiterating steps (b) through (h) so as to alternate each bed through adsorption and desorption cycles.

11. The process of claim 10 wherein the heat conductive foam comprises a reticulated metal foam wherein the metal is selected from aluminum, titanium, copper, iron, nickel, steel, aluminum steel, tin, platinum, silver, iridium, gold, and alloys of the aforementioned metals.

12. The process of claim 10 wherein the heat conductive foam comprises an aluminum, titanium, or stainless steel foam having from 5 to 80 pores per inch length and greater than 70 percent to less than 95 percent void space.

13. The process of claim 10 wherein the heat conductive foam has a relative density ranging from 2 to 15 percent.

14. The process of claim 10 wherein the sorbent is selected from amines, molecular sieves, including aluminosilicates and phosphoaluminosilicates, and metal oxides.

15. The process of claim 14 wherein the sorbent coating is selected from molecular sieve 13X, molecular sieve 5A, zeolite Y, and zeolite HZSM-5.

16. The process of claim 10 wherein the sorbent is loaded onto the heat-conductive foam in an amount ranging from 12 mg sorbent per cubic centimeter foam (mg/cm³) to 250 mg/cm³.

17. The process of claim 10 wherein the thermal conductor is selected from aluminum, titanium, copper, iron, nickel, steel, aluminum steel, tin, platinum, silver, gold, and alloys of each of the aforementioned metals.

18. The process of claim 10 wherein the target compound is selected from water, carbon dioxide, hydrogen sulfide, ammonia, volatile organic compounds, and mixtures thereof.

19. The process of claim 10 wherein the sorbent bed comprises a reticulated aluminum, stainless steel, or titanium foam, or a reticulated foam of an aluminum alloy or a titanium alloy; the thermal conductor is aluminum, stainless steel, or titanium; the sorbent is selected from amines, molecular sieve 13X and molecular sieve 5A; and the target compound is selected from carbon dioxide, water, and mixtures thereof.

20. The process of claim 10 wherein the process is conducted during the adsorption cycle at a temperature ranging from 5° C. to 50° C. and a pressure ranging from 101 kPa to 505 kPa, and/or the process is conducted during the desorption cycle at a partial pressure of the target compound ranging from 0.051 kPa to 101 kPa or a total pressure ranging from 0.051 kPa to 101 kPa.
